(19) United States
(12) Patent Application Publication
(10) Pub. No.: US 2014/0370173 A1
(43) Pub. Date: Dec. 18, 2014

(54) FROZEN CONFECTIONS WITH IMPROVED HEAT SHOCK STABILITY

(71) Applicant: NESTEC S.A., Vevey (CH)

(72) Inventors: Zeynel Deniz Gunes, Lausanne (CH); Jin-Mi Jung, Epalinges (CH); Hans Jörg Werner Limbach, Epalinges (CH); Christophe Joseph Etienne Schmitt, Servion (CH); Cédric Dubois, Nyon (CH)

(21) Appl. No.: 14/008,907

(22) PCT Filed: Mar. 19, 2012
(86) PCT No.: PCT/EP12/54787

§ 371 Date: Sep. 3, 2014

(30) Foreign Application Priority Data
Mar. 29, 2011 (EP) 11160160.5

(51) Int. Cl. A23G 9/38

(52) U.S. Cl. CPC A23G 9/38; A23V 2002/00
USPC 426/327; 426/565

(57) ABSTRACT

The present invention relates to a process for improving the heat shock resistance of frozen confections which comprises adding protein aggregates in the form of fibrils to a homogenized and pasteurized mix for frozen confection, before freezing the mix.

### FIELD OF THE INVENTION

The present invention relates to a frozen confection with improved heat shock stability. The product of the invention is characterized by the presence of protein aggregates in the form of protein fibrils. A process for preparing such frozen confection and a process for improving heat shock resistance of a frozen confection are also part of the invention.

### BACKGROUND OF THE INVENTION

Frozen confections are particularly appreciated for their creamy and smooth characteristics. However, these products, in order to preserve their optimum organoleptic characteristics of smoothness, have to be stored and handled with care. Temperature variations, even small, can be observed during storage, distribution or handling and affect the quality of the product. This is particularly the case when the consumer buys a frozen confectionery, and when there is a gap between the time when the product is taken from the deep-frozen section and when it is placed in the domestic freezer. In such circumstances, substantial or partial thawing of the product may occur before it is refrozen. Such cycles of temperature variation, called heat-shocks are responsible for a change in the microstructure of the product e.g. by the growth of ice crystals in the product. A crystallized texture results from such conditions. This coarse texture and the icy mouth feel accompanied by an impaired appearance of the product compromise or at the very least reduce its overall quality as perceived by the consumer.

Various gums and/or emulsifiers have been used as additives with the aim of improving the stability, the smoothness and the resistance of frozen confections to heat shocks. These may include guar gum, carob or guar seed flour, alginate, carboxymethyl cellulose, xanthan, carrageenan, synthetic or natural emulsifiers. However, the use of gums has the disadvantage of conferring to the product a texture which is sometimes too firm or gummy.

EP 1202638 proposes the use of particular emulsifier systems to improve heat shock resistance of frozen confections. Mixtures of propylene glycol mono stearate (PGMS) with mono- and diglycerides and sorbitan tristearate (STS) are in particular described as a very efficient system for reducing ice crystal growth during heat shock. However, these ingredients present the drawback of being negatively perceived by the consumer and therefore do not answer the growing demand for products with a cleaner label.

Proteins have been described as agents to stabilize aerated food products, where they can act as emulsifiers, surface active agents and/or bulking agents to stabilize emulsions and foams. WO 2004/049819 describes in particular the use of protein fibrils derived from β-lactoglobulin in the preparation of food stuffs, such as dairy products, for example (aerated) desserts, yogurts, flans, in bakery or confectionary applications, such as frappe, meringue, marshmallows, in cream liqueurs or in beverage foamers, such as cappuccino foamers. The use of fibrils is described as thickening agent, foaming agent, viscosity enhancing agent and/or gelling agent.

WO 2008/046732 relates to a frozen aerated food product comprising surface active fibres which have an aspect ratio of 10 to 1000. The fibres exemplified are made of a food grade waxy material, such as carnauba wax, shellac wax or bee wax.

Surprisingly it has now been found that the use of protein aggregates in the form of fibrils in frozen aerated confections have advantageous properties. In particular, it has been found that the use of such protein aggregates improves heat shock resistance of frozen confections.

### SUMMARY OF THE INVENTION

Unless otherwise specified, percentages given correspond to percentages by weight of the end product.

In a first aspect, the present invention pertains to a frozen confection, optionally aerated, with improved heat shock resistance. Said product comprises from 5 to 15% milk solids non fat, up to 20% fat, from 5 to 30% of a sweetening agent and up to 3% of a stabilizer system. The product of the invention further comprises from 0.001 to 4, preferably 0.01 to 1.5%, more preferably 0.2 to 1.5% and most preferably 0.5 to 1.5% of protein aggregates in the form of fibrils.

The present invention further relates to a process for the preparation of a frozen confection comprising mixing from 5 to 15% MSNF, up to 20% fat, from 5 to 30% of a sweetening agent and up to 3% of a stabilizer system, homogenizing and pasteurizing the mix, adding from 0.001 to 4, preferably 0.01 to 1.5%, more preferably 0.2 to 1.5% and most preferably 0.5 to 1.5% of protein fibrils to the mix and then freezing the resulting mix. Alternatively, the protein fibrils can be added to the mix before homogenization and pasteurization.

In a third aspect, the invention provides a process for improving heat shock resistance of frozen confections, comprising adding protein fibrils to a homogenized and pasteurized mix for frozen confection, before freezing said mix.

Finally, the invention provides an aseptically packaged un-frozen product for the preparation of a frozen confection, comprising from 0.001 to 4, preferably 0.01 to 1.5%, more preferably 0.2 to 1.5% and most preferably 0.5 to 1.5% of protein fibrils.

### DETAILED DESCRIPTION OF THE INVENTION

It has been found that protein aggregates in the form of protein fibrils advantageously prevent or reduce the coarsening of the air microstructure of frozen confections usually observed after heat shock and responsible for deteriorating the texture of said products. In a first aspect, the present invention thus relates to a frozen confection comprising from 5 to 15 wt % milk solids non fat (MSNF), up to 20% fat, from 5 to 30% of a sweetening agent, up to 3% of a stabilizer system and from 0.001 to 4, preferably 0.01 to 1.5%, more preferably 0.2 to 1.5% and most preferably 0.5 to 1.5 wt % of protein aggregates in the form of fibrils.

Said products have surprisingly been found to present an excellent resistance to heat shock. What is meant by heat shock stability is the ability of a product subjected to several cycles of temperature variations to maintain its microstructure i.e. to avoid coarsening of the air microstructure and/or ice crystal growth.

The applicant has found that when subjected to heat shock, the frozen confections prepared according to the process of the invention do not show any sign of coarsening.

This can be characterized e.g. by X-ray tomography (ref: R. Mousavi et al., Imaging food freezing using X-ray microtomography, International Journal of Food Science and Technology 2007, 42, 714-727.)

This technique has been used to observe the air microstructure and in particular air bubble sizes of products according to the invention compared to reference products which do not contain protein fibrils. The technique and results are further discussed in the examples.

Furthermore, the frozen confections of the invention advantageously demonstrate a comparable stability against heat shock to what can be achieved by the use of an emulsifier system based on PGMS and mono/diglcerides while answering the consumer's growing demand for products with less artificial components and other additives.

Without being bound by theory, it is believed that the performance achieved by the product of the invention is attributed to the difference in the protein structure (rods versus small spherical monomers), the presence of peptides and a much higher viscosity in the bulk.

According to a particular embodiment, the frozen confection of the invention is aerated and has an overrun of between 20% and 150%, more preferably between 40% and 120%. The overrun is defined as following:

$$Overrun \% = \frac{( volume of aerated product - Volume of mix )}{volume of mix} \times 100$$

By frozen confection, it is meant in particular a product selected from the group consisting of ice cream, sorbet, mellorine, frozen yoghurt, milk ice, slush, frozen beverage, milk shake and frozen dessert.

The milk solids non fat used in the frozen confection of the invention may be powdered or concentrated defatted sweet whey for example. They may also include powdered or concentrated skim milk. MSNF may also be derived from a commercial mixture of milk powder and modified whey proteins.

According to one embodiment, the product of the invention comprises from 0.5 to 20% fat, and preferably from 8 to 14% fat. The fat may be obtained from a vegetal source, such as e.g. palm, coconut, soybean, rapeseed, olive, palm kernel oil, hydrogenated coconut oil, hydrogenated soybean oil, palm olein and their mixtures. The fat may also be obtained from an animal source, preferably milk (cream) butter fat and/or its fractions.

The product then comprises from 5 to 30% of a sweetening agent. By “sweetening agent” it is to be understood a mixture of ingredients which imparts sweetness to the final product. These include sucrose, glucose, fructose, natural sugars like cane sugar, beet sugar, molasses, other plant derived nutritive sweeteners, and non-nutritive high intensity sweeteners.

The product may comprise a stabilizer system in an amount of from 0.1 to 3%. By stabilizer system is meant at least one emulsifier and/or stabilizer. Suitable stabiliser include carob flour, guar flour, alginates, carboxymethylcellulose, xanthan, carrageenan, locust bean gum, gelatine and starches. Any food grade emulsifier typically used in ice confection could be used. Natural emulsifiers are preferred and include for example egg yolk, buttermilk, raw acacia gum, rice bran extract or mixtures thereof. According to a particular embodiment, the product of the invention is free from propylene glycol monostearate, mono- and diglycerides.

The frozen confections of the invention are characterised by the presence of protein aggregates in the form of protein fibrils. Those fibrils are obtained from globular protein, preferably selected from the group consisting of whey proteins, blood proteins, soy proteins, soluble wheat proteins, potato proteins, pea proteins, lupin proteins and canola proteins. More preferably, the fibrils are obtained from beta-lactoglobulin or whey protein isolate.

The protein fibrils are obtainable by heating a protein solution containing 0.1 to 5% of globular protein for 30 min to 48 hours at 60° C. to 100° C. and a pH below 2.5. According to a particular embodiment, once cooled, the pH of the obtained fibril solution is adjusted to between 6 and 7 to facilitate further processing of the solution with the frozen confection mix.

When reference is made to the pH in the application, it is measured at room temperature.

Protein aggregates in the form of fibrils are meant to designate semi-flexible fibrils which can be characterized by a contour length or total length varying from 500 nm to 10 microns right after the heat treatment or from 50 nm to several microns in the final product after the fibrils have been sheared and cut down into shorter ones. The fibrils may also be characterized by their cross section which is around 4-10 nm. On the other hand, the aspect ratio is dependent on the contour length (the cross section being more or less monodisperse). For the longest fibrils, it can be more than 2500, for the shortest ones, it can be around 10.

In a second aspect, the invention pertains to a process for the preparation of a frozen confection. According to a first embodiment, in a first step, the process of the invention consists in mixing from 5 to 15% of milk solids non fat, up to 20% fat, from 5 to 30% of a sweetening agent and up to 3% of a stabilizer system. The mix is then homogenized and pasteurized. In a third step 0.001 to 4, preferably 0.01 to 1.5%, more preferably 0.2 to 1.5% and most preferably 0.5 to 1.5% of protein fibrils are added to the mix which is then frozen.

According to a particular embodiment, the pH of the mix is comprised between 6 and 7.

According to second embodiment, the fibrils are added to the initial mix, before homogenization and pasteurization.

Homogenization and pasteurization can be done in any order according to usual conditions known to a skilled person in the art. For example pasteurization is made at around 80 to 90° C. during 10 to 60 s. The mixture may then be cooled to around 2 to 8° by known means, and aged.

According to one embodiment, the mixture is then frozen at around −3° to −10° C. with steering with injection of gas so as to produce a degree of overrun of the order of 20 to 150% for example. The mixture obtained may then be further cooled by extrusion at temperature below −11° C. in a refrigerated single or twin screw extruder and hardened by freezing at around −20 to −40° C.

According to another embodiment, the mixture is quiescently frozen. By quiescent freezing, is meant subjecting a product to negative temperatures into a home freezer cabinet, or a hardening tunnel at factory or other devices where the product is kept statically at temperatures between e.g. −12° and −24° C. without any agitation or intervention.

According to a specific embodiment, the process of the invention includes the aseptic packaging of the unfrozen mix comprising the protein fibrils to allow a further quiescent freezing, e.g. by a consumer in a home freezer.

Preferably the globular protein used to form the protein fibrils is selected from whey proteins, blood proteins, soy proteins, wheat proteins, potato proteins, pea proteins, lupin proteins and canola proteins. We particularly prefer β-lactoglobulin or whey protein isolate.

Protein fibrils added to the mix in the process of the invention are obtainable by heating a globular protein solution containing from 0.1 to 5 wt % of globular protein, for 30 min to 48 hours, at a temperature from 60° to 100° C. and a pH below 2.5 to produce protein aggregates in the form of fibrils. Once cooled, the pH of the fibril solution is preferably adjusted to a value of between 6 and 7.

Preferably, the fibrils are obtainable by heating a protein solution containing from 2 to 4% of the globular protein. Preferably, the protein solution is heated from from 2 to 10 hours.

Preferably, the protein solution is heated at a temperature of from 80° C. to 98° C.

Preferably the protein solution is heated at a pH below 2. Preferably the pH is above 1.

The invention then also relates to a process for improving heat shock resistance of a frozen confection which comprises adding 0.001 to 4, preferably 0.01 to 1.5%, more preferably 0.2 to 1.5% and most preferably 0.5 to 1.5% of protein aggregates in the form of protein fibrils to a homogenized and pasteurized mix comprising from 5 to 15% of MSNF, up to 20% fat, from 5 to 30% of sweetening agent, and up to 3% of stabilizer system before freezing the resulting mix.

### FIGURES

The present invention is further described hereinafter with reference to some embodiments shown in the accompanying figures in which:

FIG. 1: is a TEM micrograph of beta-lactoglobulin fibrils obtained upon heat treatment (negative staining). Scale bar represents 0.5 micron.

FIG. 2: represents a heat shock cycle.

FIGS. 3a and 3b: are X-ray tomography images of respectively a reference and a product of the invention as described in Example 1, after two heat shock cycles.

FIGS. 4a and 4b: represent a pore thickness distribution and cumulative distribution for a reference, respectively a product of the invention as described in Example 2, after two heat shock cycles.

FIGS. 5a and 5b: are X-ray tomography images of respectively a reference and a product of the invention as described in Example 2, after two heat shock cycles.

FIG. 6: is a tomography image of fresh ice cream, which has not been subjected to heat shock cycles

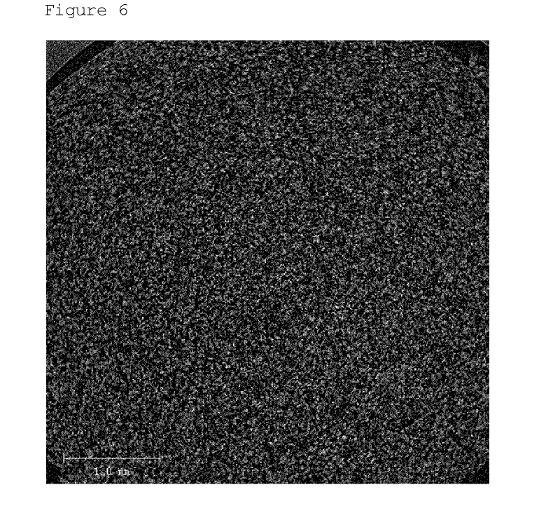

The present invention is further illustrated by means of the following non-limiting examples.

### Example 1

### Preparation of Protein Fibrils

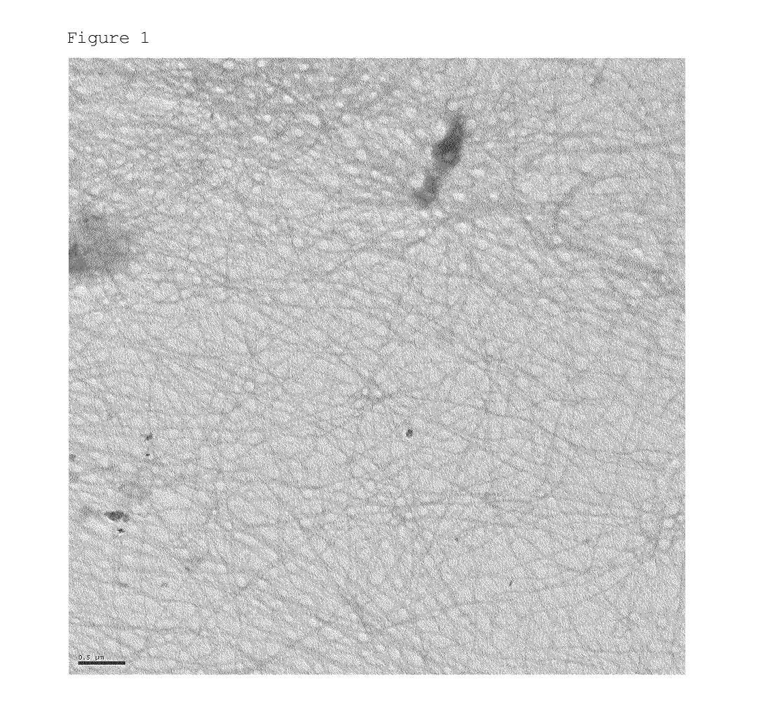

β-Lactoglobulin isolate and water were mixed at room temperature and the pH was adjusted to 2 with concentrated HCl. The solution contained 4 wt % of 13-Lactoglobulin isolate (equivalent to 3.46 wt % of 13-Lactoglobulin).
The solution was rapidly heated under gentle steering to T=90° C. and kept at that temperature for 5 hours.
The solution was rapidly cooled and then stored at T=4° C. Samples were taken to prove the aggregation status of the fibrils with help of electron microscopy, as shown in FIG. 1 which is a TEM micrograph of beta-lactoglobulin fibrils obtained upon heat treatment (negative staining)*
The conversion rate ** into protein fibrils for this process was 75%

Transmission Electron Microscopy (TEM)

A drop of the diluted solution (1-0.1% final wt concentration) was casted onto a carbon support film on a copper grid. The excess solution was removed after 30 seconds using a filter paper. Contrast to electrons was achieved by negative staining by adding a droplet of Phosphotungstic acid solution 1% (PTA, pH 7, Sigma-Aldrich, Switzerland) onto the grid, during 15 seconds, after deposition of b-lactoglobulin aggregates solution. Any excess of staining agent was removed again by a filter paper. Electron micrographs were acquired on a CCD camera using a Philips CM100 Biotwin Transmission Electron Microscope operating at 80 kV.

Conversion Rate

The initial concentration of native b-lactoglobulin was checked by UV/vis-spectroscopy at 278 nm, using a Uvikon 810 spectrophotometer (Kontron Instruments, Flowspec, Switzerland). The extinction coefficient for the calibration was determined experimentally using known concentrations of b-lactoglobulin solutions at pH 2.0, where the b-lactoglobulin is present as monomer. The determined value, ε278=0.8272 L·cm−1.g−1 is in agreement with the literature.

The conversion rate was determined by UV/vis-spectroscopy at 278 nm. The heat-treated solution was diluted with MilliQ water and precipitated at pH 4.6, centrifuged at 22000 g during 15 min at 20° C. using Sorvall Evolution RC High Speed Centrifuge. The absorbance of the supernatant was read at 278 nm, yielding the concentration of non-aggregated b-lactoglobulin. The difference between the initial b-lactoglobulin concentration and the non-aggregated b-lactoglobulin concentration gives the amount of aggregated b-lactoglobulin, its ratio over the initial concentration being referred as the conversion yield.

Ice Cream Comprising Protein Fibrils

### Preparation

Two separate mixes were prepared. The first mix (ice cream mix), contained all ingredients except the beta-lactoglobulin. The second mix, (protein fibril solution), contained beta-lactoglobulin and was processed as described in the above-paragraph.

### Ice Cream Mix Preparation

All ingredients were mixed with water at T=60° C.
The mix was kept at T=60° C. and all ingredients let hydrate for 2 hours.
The mix was then run through a pasteurization/homogenization line. Pasteurization was done at 86° C. for 30 seconds. Homogenization was done with a high pressure homogenizer (APV, type: APV-mix) with two stages at 140 and 40 bars respectively.
The mix was then kept at T=4° C. in order to maturate for 12 to 20 hours.

### Ice Cream Production

The ice cream mix and the protein fibril solution were mixed together under slow stirring in a vessel at T=4° C. (50 kg ice cream mix with 22.961 kg protein fibril solution). The total solids content of the final mix was TS=38.3 wt %. The concentration of beta-lactoglobulin was 1.09 wt % whereas the concentration of protein fibrils was 0.82 wt % (given a conversion rate of 75%). The final mix was at pH4.7. The ice cream was produced in a Hoyer freezer (Technohoy MF 50). The outlet temperature was set to −5° C., the back pressure to 1.5 bars and the dasher speed to 500 rpm.
The ice cream was filled into 120 ml plastic cups.

### Recipes:

1. Test Ice cream
(i) Ice cream mix:

| | Mass |
|---|---|
| Ingredient | [wt %] |
| Water | 45.835 |
| Dried glucose syrup (DE 40) | 16.191 |
| Sucrose | 13.247 |
| Coconut fat | 10.745 |
| Lactose | 7.860 |
| Skim milk powder | 3.238 |
| Dextrose monohydrate | 2.208 |
| Emulsifier/Stabilizer | 0.677 |

(ii) Protein fibril solution

| | Mass |
|---|---|
| Ingredient | [wt %] |
| Water | 96.154 |
| Beta Lactoglobulin Isolate | 3.846 |

2. Reference ice cream

| | Mass |
|---|---|
| Ingredient | [wt %] |
| Water | 61.140 |
| Dried glucose syrup (DE 40) | 9.500 |
| Sucrose | 9.000 |
| Milk protein replacer - | 8.900 |
| 15% whey protein content | |
| Coconut fat | 7.300 |
| Skim milk powder | 2.200 |
| Dextrose monohydrate | 1.500 |
| Emulsifier/Stabilizer | 0.46 |

The results were compared against an ice cream made from the recipe ‘reference ice cream’. The reference recipe contains around 1.5 wt % whey proteins from milk and was made so that it contains the same sugar content as the recipe of the product of the invention.

### Heat Shock Stability Test

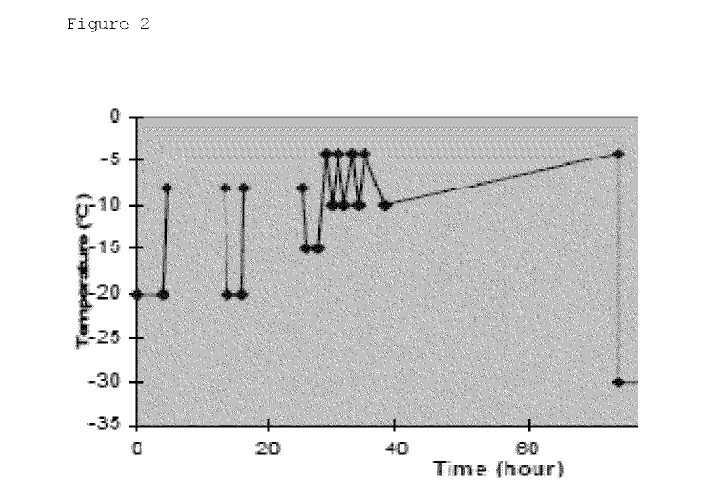

The air microstructure of the ice creams has been investigated with help of x-ray tomography (Scanco medical μCT 35 operated in a cold room at T=−16° C.) before and after heat shock. Two cycles of a 72 hour heat shock protocol were applied, as shown in FIG. 2.

The ice cream samples were scanned using a custom designed high resolution desktop computerized tomography instrument (Scanco mCT 35, Scanco Medical AG, Brütisellen, Switzerland). The ice cream samples were kept at −25° C. during the 1.5 hour measurement time. A voxel and instrument resolution of 4.5 micrometers (10% Modulated Transfer Function) was used. The 3D images reconstructed from the sinograms used a Shepp & Logan filtered back-projection extended to a cone-beam geometry.

The method used to quantify the air microstructure consisted of 1) applying an anisotropic diffusion filter to the raw data (ref: P. Perona and J. Malik, Scale-Space and Edge Detection Using Anisotropic Diffusion, IEEE Transactions on Pattern Analysis and Machine Intelligence, 12(7):629-639, July 1990); 2) segmenting the resulting data using the local minima of the voxel gray value histogram as threshold; 3) calculating the resulting air microstructure (i.e. pore) thickness distribution in 3D using the algorithm proposed by Hildebrand and Ruegsegger (1997) (ref: Hildebrand, T. & Ruegsegger, P., A new method for the model-independent assessment of thickness in three-dimensional images, Journal of Microscopy, 1997, 185, 67-75)

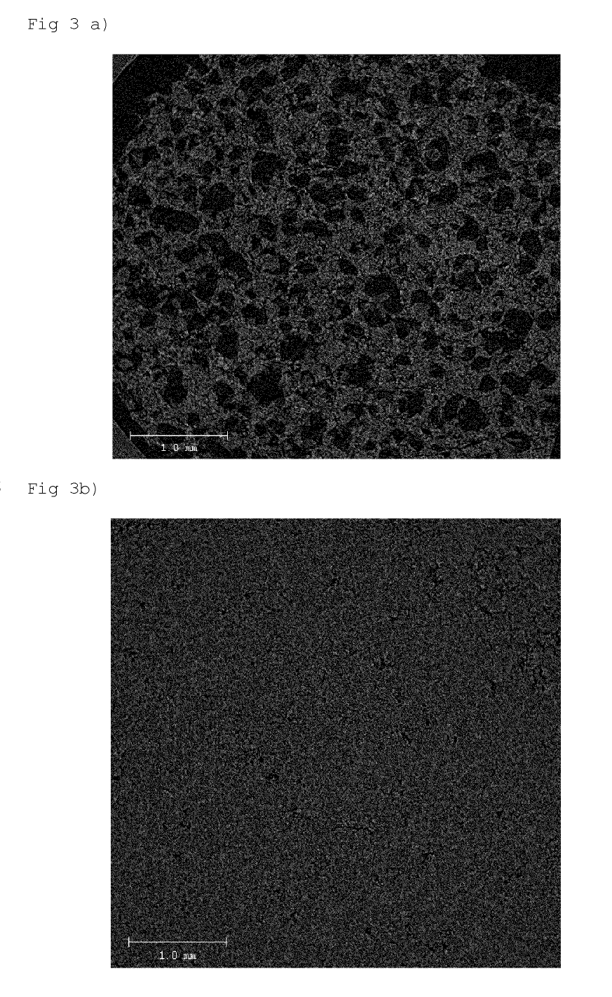

Tomography images are represented in FIGS. 3a (reference) and 3b (ice cream according to the invention).

The images clearly show a strong coarsening of the air microstructure after heat shock for the reference ice cream whereas the ice cream containing protein fibrils does not show any sign of coarsening. Given the resolution limit of around 15 μm of our x-ray microtomography (voxel size and instrument resolution 4.5 μm) due to the fact that image analysis requires objects containing a sufficient number of voxels to be unambiguously identified as an individual object. It is concluded that the air microstructure of the ice cream containing protein fibrils is smaller than 15 μm after heat shock while air bubbles are as large as 250 μm in the reference ice cream after heat shock.

### Sensory

A panel tasted the fresh products (test ice cream and reference ice cream) just after their preparation and without being subjected to heat shock. Tasting of the fresh ice creams did not reveal significant differences in texture attributes.

### Example 2

### Preparation of Protein Fibrils

β-Lactoglobulin isolate and water were mixed at room temperature and the pH was adjusted to 2 with concentrated HCl.
The solution was rapidly heated under gentle steering to T=90° C. and kept at that temperature for 5 hours.
The solution was rapidly cooled and then stored at T=4° C.
pH was adjusted to 6.7 with fast addition of NaOH
Samples were taken to prove the aggregation status of the fibrils with help of electron microscopy.
The conversion rate into protein fibrils for this process was 75%.

Ice Cream Comprising Protein Fibrils

### Preparation

Two separate mixes were prepared. The first mix (ice cream mix), contained all ingredients except the beta-lactoglobulin. The second mix, (protein fibril solution), contained beta-lactoglobulin and was processed as described in the above-paragraph.

### Ice Cream Mix Preparation was Done as in Example 1

### Ice Cream Production

The ice cream mix and the protein fibril solution were mixed together under slow stirring in a vessel at T=4° C. (50 kg ice cream mix with 22.961 kg protein fibril solution). The concentration of beta-lactoglobulin was 1.1 wt % whereas the concentration of protein fibrils was 0.8 wt % (given a conversion rate of 75%). The final mix was at pH 6.7. The ice cream was produced in a Hoyer freezer (Technohoy MF 50). The outlet temperature was set to −5° C., the back pressure to 1.5 bars and the dasher speed to 500 rpm.
The ice cream was filled into 120 ml plastic cups.
   Recipes: Please refer to Example 1.

The results were compared against an ice cream made from the recipe ‘reference ice cream’. The reference recipe contains around 1.5 wt % whey proteins from milk and was made so that it contains the same sugar content as the recipe of the product of the invention.

### Heat Shock Stability Test

Heat shock stability test was performed in the same conditions as described in Example 1.

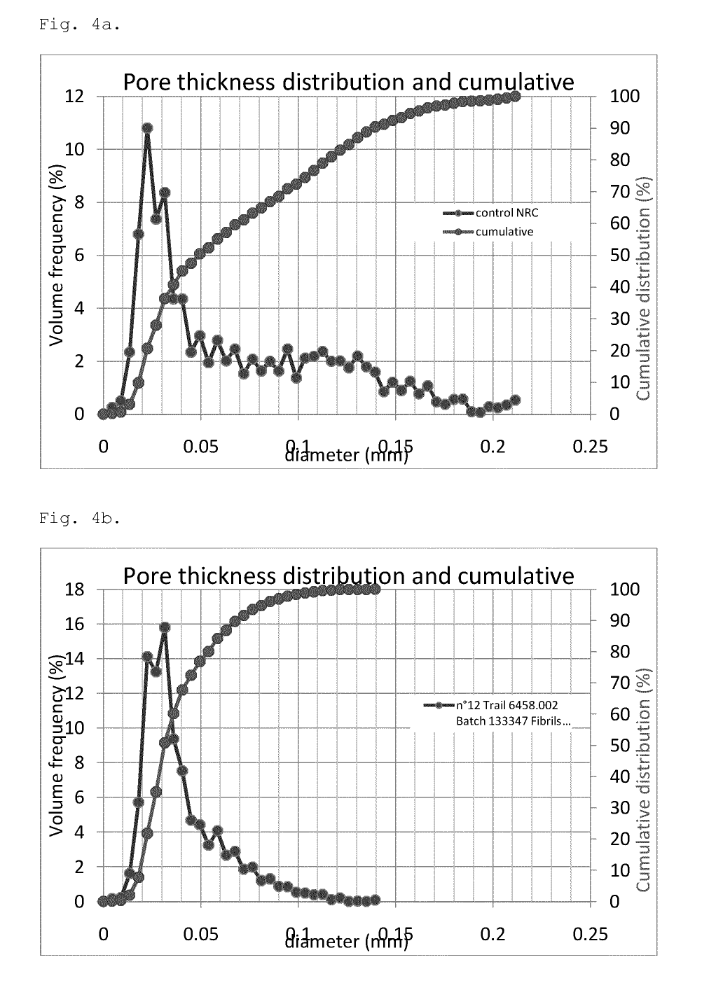

FIGS. 4a and 4b represent the pore thickness distribution and cumulative distribution. The pore thickness distribution represents the volumetric fraction of the air microstructure which has a thickness given by the corresponding diameter in the horizontal axis. The cumulative distribution describes the proportion of the air microstructure whose thickness is less than the corresponding diameter in the same horizontal axis.

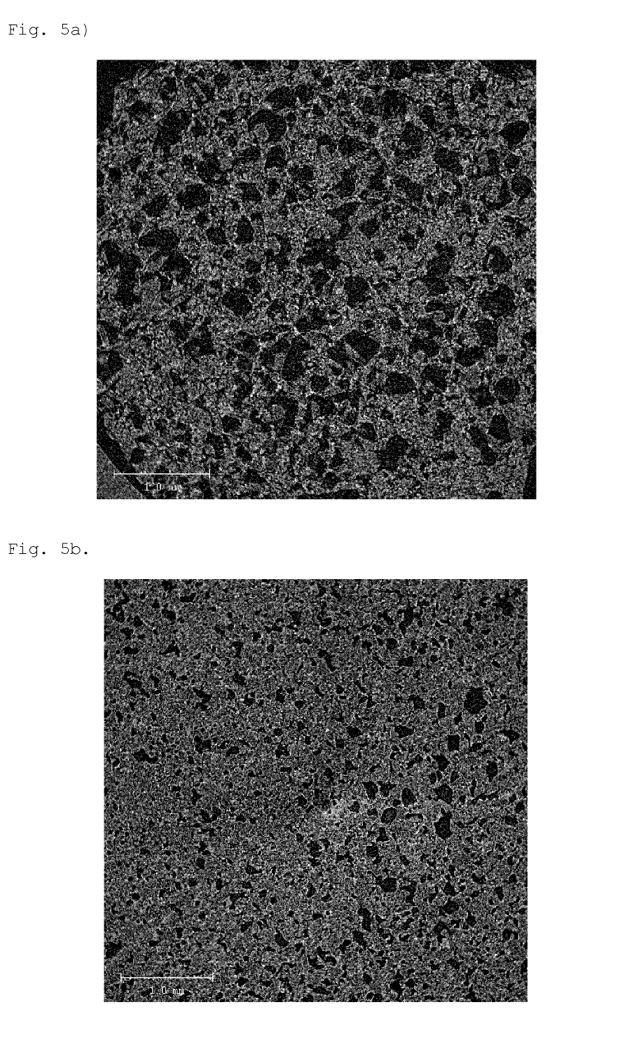

Corresponding 2D tomography images are represented in FIGS. 5a (reference) and 5b (ice cream according to the invention).

It can be clearly seen by comparing FIG. 5a and FIG. 5b that the air microstructure of the ice cream containing the protein fibrils (FIG. 5b) has coarsened much less than the reference ice cream. With help of the pore thickness distributions shown in FIG. 4a and FIG. 4b this effect has been quantified. From the cumulative distribution one can for example infer that for the reference ice cream around 50 volume % of the air is contained in air microstructure with a characteristic size smaller than 50 micrometers whereas for the ice cream containing protein fibrils this is the case for more than 75 volume % of the air.

1-15. (canceled)

16. A frozen confection comprising from 5 to 15% milk solids non fat, up to 20% fat, from 5 to 30% of a sweetening agent, up to 3% of a stabilizer and from 0.001 to 4% of protein fibrils.

17. A frozen confection according to claim 16, having an overrun of between 20% and 150%.

18. A frozen confection according to claim 16 selected from the group consisting of ice cream, sorbet, mellorine, frozen yoghurt, milk ice, slush, frozen beverage, milk shake, and frozen dessert.

19. A frozen confection according to claim 16 comprising from 0.1 to 3% of a stabilizer system.

20. A frozen confection according to claim 19, wherein the stabilizer system is free of polyglycerol ester of fatty acids, mono- and diglycerides.

21. A frozen confection according to claim 16, wherein the protein fibrils are made from a globular protein selected from the group consisting of whey proteins, blood proteins, soy proteins, wheat proteins, potato proteins, pea proteins, lupin proteins and canola proteins.

22. A frozen confection according to claim 16, wherein the protein fibrils are made from β-lactoglobulin or whey protein isolate.

23. A frozen confection according to claim 16, comprising from 0.5 to 20% of fat.

24. A process for preparing a frozen confection, the process comprising
mixing from 5 to 15 wt % milk solids non fat, up to 20% fat, from 5 to 30% of a sweetening agent and up to 3% of a stabilizer system;
homogenizing and pasteurizing the mix;
adding 0.001 to 4% of protein fibrils to the mix; and
freezing the mix to form a frozen confection.

25. A process according to claim 24, wherein the protein fibrils are obtainable by heating a protein solution containing from 0.1 to 5% of globular protein for 30 min to 48 hours at 60° to 100° and a pH of less than 2.5.

26. A process according to claim 24, wherein the mix is aerated during the freezing step.

27. A process according to claim 24, wherein the freezing is followed by a dynamic cooling of the mix to a temperature below −11° C.

28. A process according to claim 24, wherein the freezing is quiescent.

29. A process according to claim 24, wherein before being frozen, the un-frozen mix is aseptically packaged.

30. A process for improving heat shock resistance of a frozen confection comprising adding from 0.001 to 4% of protein fibrils to a homogenized and pasteurized mix comprising from 5 to 15% milk solids non fat, up to 20% fat, from 5 to 30% of a sweetening agent and up to 3% of a stabilizer system, and then freezing the resulting mix.

31. Aseptically packaged un-frozen mix for the preparation of a frozen confection, wherein the mix comprises from 0.001 to 4% of protein fibrils.
